(19) United States
(12) Patent Application Publication
(10) Pub. No.: US 2003/0106699 A1
(43) Pub. Date: Jun. 12, 2003

(54) Device and method for raising an animals's hoof

(76) Inventors: Siegfried Reiss, Rosbach (DE); Siegfried Demel, Nidderau (DE)

Correspondence Address: MUSERLIAN AND LUCAS AND MERCANTI, LLP, 600 THIRD AVENUE, NEW YORK, NY, 10016, US

(21) Appl. No.: 10/332,402

(22) PCT Filed: Jul. 12, 2001
(86) PCT No.: PCT/EP01/08049

(30) Foreign Application Priority Data
Jul. 12, 2000 (DE) 100 33 822.4

(51) Int. Cl. A01L 7/00

(52) U.S. Cl. 168/44

(57) ABSTRACT

The invention relates to a device for raising the hoof of an animal such as a cow, comprising a shoe (24), such as a wooden block, to be fixed to the hoof. Said shoe can be fixed to the hoof by means of a connecting medium such as a single or multi-component adhesive. The invention enables the shoe to be fixed simply and unproblematically to the hoof, and any unevenness to be easily leveled out. In order to achieve this, a porous material comprising a reactive adhesive, or a component provided with or consisting of one such adhesive, is applied to the hoof-side surface (26) of the shoe (24), forming the connecting medium between the shoe and the hoof.

The invention relates to a device for raising the hoof of an animal such as a cow, comprising a shoe to be fixed under the hoof. Said shoe can be fastened to the hoof by means of a connecting medium such as a single or multi-component adhesive. Furthermore, the invention relates to a method for raising the hoof of an animal, such as a cow, by affixing a shoe to the hoof by means of an adhesive.

Stabling, feeding and high-production breeding often result therein that the animals' hoofs become diseased. The result is lameness which leads thereto that the high milk output falls off, in particular in dairy cows. Lameness leads to pain in the animals and to significant economic losses due to loss of milk output and due to weight losses in the owners' animals.

Relieving the pressure on the diseased hoof by attaching a shoe under the healthy hoof has shown to be an extremely quick and effective method for alleviating pain and expediting healing in lameness. In this case, the existing hoof treatment systems are fundamentally based on the following principles. In the oldest method, iron mountings are used, however, they are seldom used nowadays since manufacturing is costly and processing is too extensive. Furthermore, rubber blocks are known which are fastened to the hoof with a single-component adhesive (cyanacrylate).

It is also possible to nail the rubber blocks. However, this is problematic and can often lead to injuries to the healthy hoof. To treat two diseased hoofs, plastic shoes are used which are fastened to the hoof by bands, straps or cords. However, the significance of corresponding plastic shoes is declining since the desired results can scarcely be attained. By far the most common is the fastening of wood blocks which, just as rubber blocks and plastic shoes, are fastened by means of reactive adhesives that can be single or multi-component adhesives.

Common single-component systems are cyanacrylate-based which have the advantage that they harden quickly. However, a clean working is necessary. It is also not possible to level out unevennesses, so that an inadequate or poor adhesion occurs in uneven hoof surfaces and/or moisture. Furthermore, the adhesive material can not essentially be shaped.

Multi-component reactive adhesives which can consist of a powder/liquid system, preferably polyester or polymethylmethacrylate-based, are used. Despite the fact that special precautions must be taken due to inflammability, corresponding powder/liquid systems have a long storage time, quick hardening, good levelling out of unevennesses and a good adhesion. However, mixing is required since the system consists of two components. In this case, there is a hardening problem at low temperatures.

Further possible two-component systems used are based on liquid/liquid and/or paste/paste, which can be synthetized on the basis of epoxide, acrylate (methacrylate), polyester or polyurethane. A quick hardening and good adhesion is also advantageous. However, extensive processing is required so that the systems are often only available in two-chamber cartridges with special mixing heads and ejectors. In this case, if polyurethane systems are offered, one can also work at low temperatures, i.e. the adhesive hardens. Nevertheless, there are disadvantages with respect to limited storage stability—only six months in most cases—and the poor moldability.

A further two-component system is the so-called NO MIX process, in which the one component is applied to the foot or to the hoof and the other one to the shoe. Thus, no mixing is required. Rather, the required bonding takes place by pressure action. However, the disadvantage is that the layer can only be applied in the millimeter range, so that it is not possible to level out unevennesses.

The object of the present invention is to provide a device for raising a hoof of an animal and a method therefor which enables a problem-free and simple fastening of the shoe to the hoof, wherein unevennesses can be levelled out without difficulty. At the same time, the advantages of the single and multi-compnoent adhesive systems should be attainable without assuming their disadvantages.

According to the invention, the object is essentially solved by a device of the aforementioned type therein that a porous material provided with a reactive adhesive or a component thereof or consisting of said adhesive is provided on the hoof-side surface of the shoe to form the connecting medium. Preferably, the porous and especially hardenable material is a substrate, such as a layer, situated on the shoe which is connected with the shoe. The porous hardenable material can also be formed on the shoe-side surface of the shoe. Furthermore, it is provided that the porous hardenable material is absorbent and provided with a component of a two or multi-component adhesive, e.g. impregnated with it, or consists of it.

Alternatively, it is also possible that the porous material be impregnated with a single-component adhesive material, in particular cyanacrylate-based, and/or with an adhesive that has been microencapsulated and/or hardened by radiation.

Preferably, the porous hardening material is a foam layer or a part of such a layer and/or consists of a fleece-like absorbent material, e.g. filter paper, and/or of a similar material, e.g. textiles, and/or of an extruded material, e.g. cellulose, and/or glass fibers.

In particular, the porous hardening material is a part of a foam with closed and/or open pores, the thickness of the foam should be in the range of between 0.1 mm and 30 mm, in particular however in the range of between 3 mm and 10 mm. The foam material itself should have a pore size of 0.01 mm to 5 mm, in particular between 0.1 mm and 2 mm.

The teaching of the invention makes it possible to easily connect a shoe, such as a wood block, to the hoof of an animal, in particular a cow. In this case, the advantage of a single-component system is also utilized when the adhesive is a multi-component adhesive, since the otherwise required homogeneous mixing of the components by the user is not required when using two-component adhesives. For this purpose, it is provided that a substrate be applied to the surface of the shoe to be connected to the hoof which consists of the porous, absorbent and hardening material and impregnated, in particular, with a first component. In this case, the substrate can be securely connected to the shoe at the manufacturing end or be delivered as a separate part. The substrate containing the first component is absorbent, so that the second component of the adhesive can be absorbed without difficulty. Preferably, the second component is a liquid or pasty component. Due to the large surface of the porous hardening material, mixing the second component with the first is unnecessary.

As previously noted, the substrate, i.e. the porous hardening material, may consist of various, sufficiently absorbent materials. For cost reasons, a commercial plastic foam is available for this purpose which is impregnated with the first component or is impregnated on site. An open-pore pad or tampon containing the first component can also be used as absorbent material.

Due to the teaching of the invention and, in particular, the use of the porous hardening material which performs a substrate function, various adhesive systems can also harden in thicker layers, even single-component systems such as cyanacrylate or microencapsulated single-component systems which harden thusfar only in thin layers under air exclusion or pressure through the large surface of the material which is obtained by the pore structure. Furthermore, it is also easily possible to harden single-component materials by ultrasound, high-frequency radiation, electromagetic radiation such as light or microwaves.

The porous substrate can be made available technically, e.g. by punching and/or cutting to any desired shape, so that a specific fastening of the part to be affixed is given. As a result, the advantage is obtained that the substrate only makes a connection in those areas between the hoof and the shoe in which the usual freedom of movement or motions of the animals, such as cows, are not affected. In particular, the soft and sensitive ball area of the foot can be kept freely mobile without difficulty during a hoof treatment without the plastic or adhesive affecting it, as must be taken into account according to the prior art, unless the plastic or adhesive is removed in desired areas. This is done prior to hardening with a scraper or similar device. If this is not done correctly, considerable disadvantages result.

In other words, based on the teaching of the invention, it becomes possible to preset any geometries desired of the porous material, i.e. the substrate, via which the shoe and the hoof are connected, so that an anatomically optimal fastening of the shoe is given.

It is also possible to form recesses on the hoof-side surface of the porous material to protect or remove the pressure from areas that are endangered by pressure. Furthermore, cavities can be created to introduce cure-expediting substances or medications into them that have a long-acting effect and expedite healing.

A method for raising the hoof of an animal, such as a cow, by fastening a shoe to the hoof is characterized by the following procedural steps:

fastening a porous material of a desired flat extension to the shoe, the material having been provided with a first component of a reactive adhesive prior to or after fastening to the shoe,

providing the material having the first component with a second component of the adhesive,

pressing the shoe with the material containing the first and second component against the hoof and

hardening the adhesive for fixing the shoe to the hoof.

Alternatively, it is possible to fasten a porous material of a desired flat extension to the shoe, the material having been provided with a single-component adhesive material prior to or after fastening to the shoe, pressing the shoe against the hoof and hardening the single-component adhesive for fixing the shoe to the hoof. In this case, the hardening can be accomplished and/or assisted by ultrasound, high-frequency radiation, electromagnetic radiation, such as light or microwave radiation.

In particular, a two-component adhesive based on urethane, acrylate/methacrylate, polyester, acrylic acid and/or epoxy resin is used.

The porous material is impregnated, in particular, with a peroxide and/or a substituted barbituric acid, preferably dibenzoyl peroxide and/or a 5-substituted barbituric acid.

The polymerizing component itself can contain catalysts such as amines or quarternary ammonium salts, metal ions, preferably p-toluidines, copper/cobalt ions and quarternary ammonium chlorides.

According to a further proposal of the invention, it is provided that a monomer based on polyester and/or acrylate/methacrylate, preferably styrene or methyl-, ethyl-, n-alkyl-methacrylate and/or hydroxy(-ethyl-,propyl-,n-alkyl)-methacrylate/acrylate and/or di-tri-tetra-methacrylates/acrylates be used as polymerizing component.

Further details, advantages and features of the invention can be found not only in the claims, the features to be found therein—alone and/or in combination—but also in the following description of preferred embodiments that can be found in the drawings, showing:

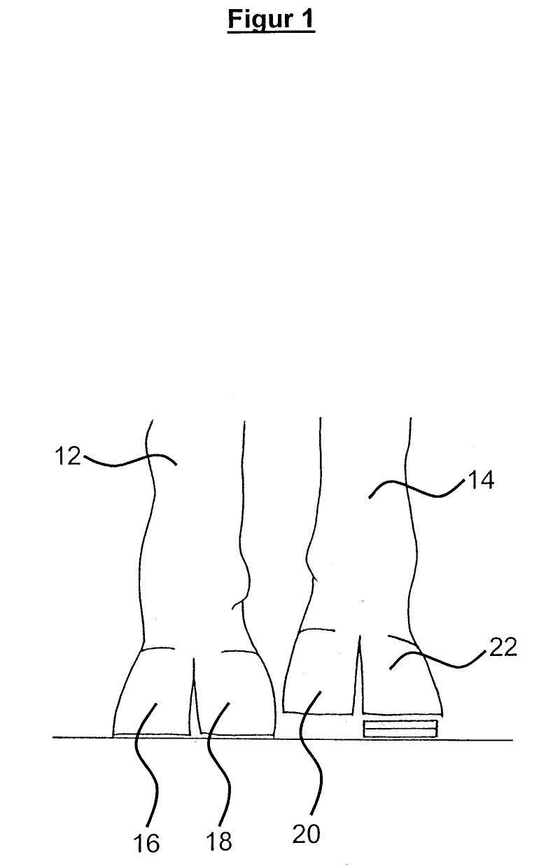

FIG. 1 parts of the legs of an animal,

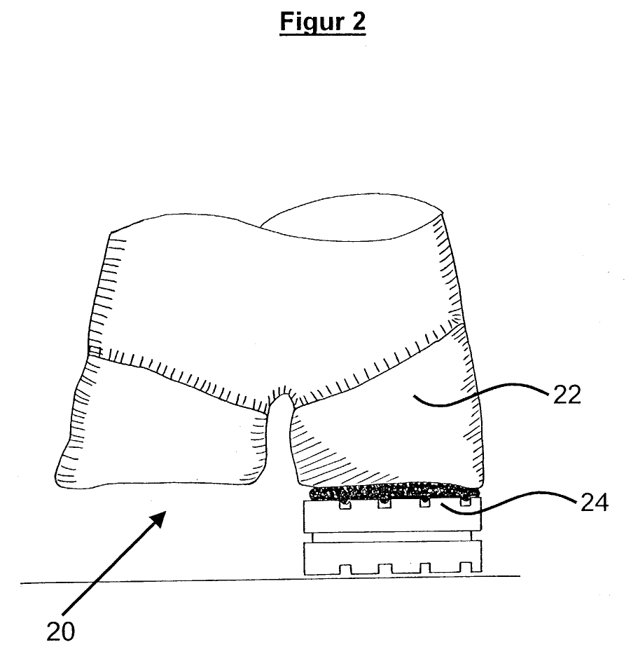

FIG. 2 a pair of hoofs, one of which is raised,

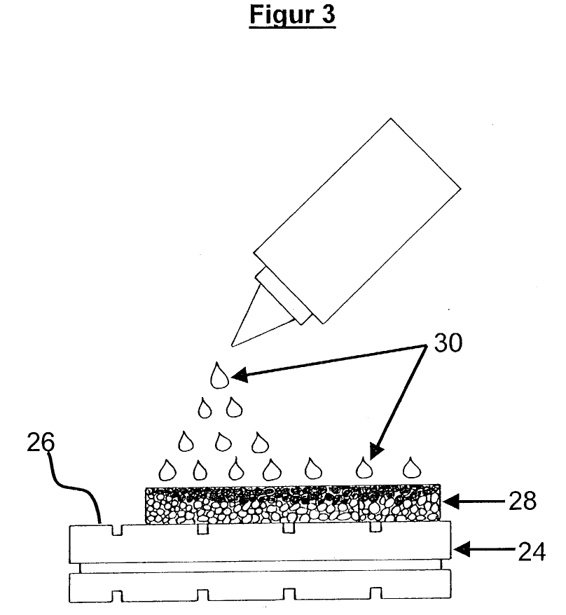

FIG. 3 a basic representation of a device comprising a shoe to be connected with a hoof that is to be raised,

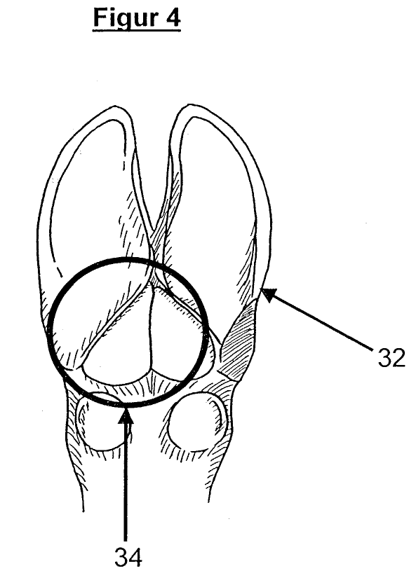

FIG. 4 a bottom view of an animal's foot,

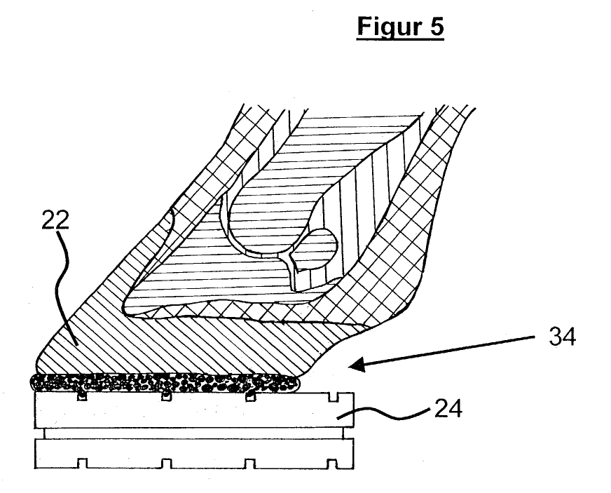

FIG. 5 a side view of the foot according to FIG. 4 with the shoe connected to raise it,

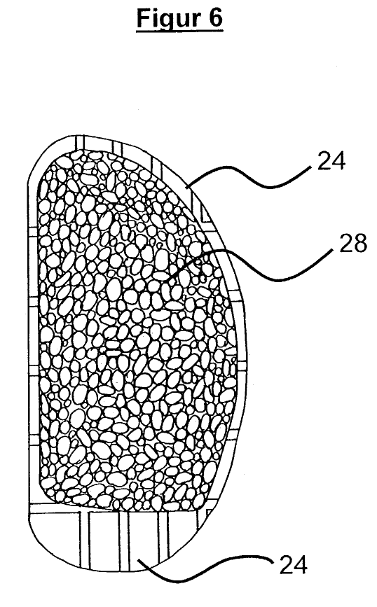

FIG. 6 a basic representation of a shoe with a substrate applied to it and

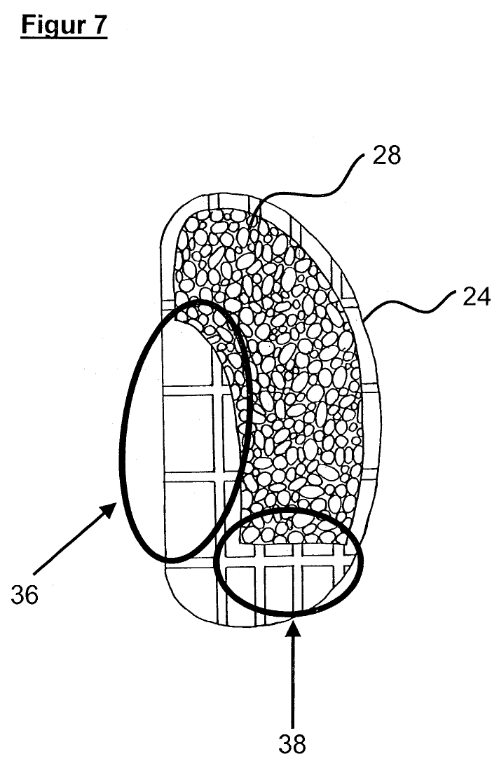

FIG. 7 an alternative construction of a substrate applied to a shoe.

Especially due to stabling, feeding and high-production breeding, it has become necessary to ascertain to a greater extent that an animal's hoofs are diseased. This results in lameness. To alleviate the pain and, at the same time, to expedite healing, it is known to relieve the pressure on the diseased hoof. As long as one of the two hoofs is healthy, it can be raised by means of a shoe.

Merely by way of example, FIG. 1 shows sections of an animal's legs 12, 14, such as in particular a cow, one of whose hoofs 16, 18, 20, 22 is diseased, namely hoof 20. To relieve the pressure on it, as noted above, a shoe 24 is fastened under the adjacent healthy hoof 22, as a result of which the pressure on the diseased hoof 20 is relieved, as shown in principle in FIG. 2.

For this purpose, according to the invention, it is provided that a porous material be attached to the hoof-side surface 26 of the shoe 24, said porous material being configured as a plate element 28 in the embodiment of FIG. 3. This plate element 28, which can also be described as a substrate, has a first component of a reactive adhesive, such as a multi-component adhesive. Due to the porous structure of the plate element 28, a large surface is produced, so that, when the shoe 24 is to be connected to the hoof 22 by means of the plate element or substrate, it is only necessary to apply the further component(s) required for the hardening to the plate element 28 or the substrate, said component(s) being designated with the reference number 30 in the embodiment shown. Due to the aforementioned large surface of the porous substrate 28, an automatic “mixing” of the components takes place when the component or components 30 penetrate into the substrate 28, so that, when the shoe 24 is pressed onto the hoof 22 with the substrate 28 containing the components, the shoe 24 is firmly fixed to the hoof 22 when the adhesive hardens. At the same time, the porous substrate 28, which can e.g. by a foam material, hardens to the required extent, so that a rigid unit consisting of shoe 24 and substrate 28 results which is connected with the hoof 22.

The substrate 28 can be provided as a prefabricated unit with the shoe 24. Alternatively, it is possible to offer shoe 24 and substrate 28 separately, so that they can then be connected together according to the respective application.

The porous material, i.e. the substrate 28, can be provided as a prefabricated part such as a plate, strip or the like, which can, optionally, be cut or punched to enable it to be connected with the shoe 24 in a specified manner in predetermined areas of the hoof 22. This results in the advantage that sensitive areas of the foot 32, in particular in the ball area 34, remain free so that the animal's usual freedom of movement and motions are not disturbed. This is made clear with reference to FIGS. 4 and 5. It can be seen that the ball area 34 is uncovered, so that the shoe 24, in particular a wood block, is connected to the hoof 22 outside of the ball area 34 via the substrate 28 or the adhesive.

Thus, an anatomically optimal fastening of the shoe 24 to the hoof 22 becomes possible. To this end, it is only necessary that the porous substrate 28 be removed in predetermined areas, as a comparison of FIGS. 6 and 7 shows. In this way, areas 36, 38 which could otherwise perhaps impede movement are removed from the substrate 28 in FIG. 7.

Furthermore, it is possible to introduce substances or medications into the substrate 28 that expedite healing. For this purpose, cavities can be provided from which long-acting substances or medications can be released.

If the invention is described with reference to a multi-component adhesive with which the substrate 28 is impregnated with one component and saturated with a second component or with the required components, such as liquid or paste, prior to processing the substrates 28, i.e. connecting the shoe 24 with the hoof 22, said substrates being absorbent, to obtain the hardening and thus make the connection between the shoe 24 and the hoof 22, then it is also easily possible that the hardening is initiated by a “static catalyst” present in the substrate 28, which could e.g. be activated by pressure, air exclusion or by waves or radiation.

It is also possible within the scope of the invention to form the substrate 28 itself from one of the components of the adhesive. If desired, a connection can also be made by a single-component adhesive, preferably cyanacrylate-based, whereby either the substrate 28 itself consists of the single-component material or is impregnated with it. Even with use of a multi-component adhesive, the substrate 28 itself can be made from one component. It is only important that the substrate be sufficiently porous and thus absorbent, so that the required apparent intermixing of the components takes place when the further component or components are added, with the result that it enables a hardening and thus a connection between the shoe 24 and the hoof 22.

The porous material which, as mentioned, is called a substrate 28 for reasons of simplification preferably consists of a foam material with closed or open pores, the foam having a layer thickness of 0.1 mm to 30 mm, preferably 3 mm to 100 mm. The pore size itself can be between 0.01 mm and 5 mm, in particular between 0.1 mm and 2 mm, without hereby wanting to restrict the invention.

In particular, a two-component adhesive that is based on urethane, acrylate/methacrylate, polyester, acrylic acid and/or epoxy resin can be used as the adhesive material.

A peroxide and/or a substituted barbituric acid, preferably dibenzoyl peroxide and/or a 5-substituted barbituric acid is preferred as impregnating component.

The polymerizing countercomponent corresponding to the first component, which can also be called impregnating component, may also contain a catalyst such as amines or quarternary ammonium salts, metal ions, preferably p-toluidines, copper/cobalt ions and quarternary ammonium chlorides.

The polymerizing component itself should be a monomer based on polyester and/or acrylate/methacrylate, preferably styrene or methyl-, ethyl-, n-alkyl-methacrylate and/or hydroxy(-ethyl-,propyl-,n-alkyl)-methacrylate/acrylate and/or di-tri-tetra-methacrylates/acrylates.

Thus, the porous material 28 consists of a countercomponent of a reactive adhesive alone and/or of a reactive partner for a further adhesive component.

As noted, if the porous material is impregnated with a so-called single-component material or consists of a single-component material, a cyanacrylate-based component should preferably be selected. It is also possible to impregnate the porous material with a micro-encapsulated adhesive and/or an adhesive that is to be hardened by radiation or waves.

The porous material itself should be absorbent and can consist of a fleece-like material, such as e.g. filter paper or similar material, such as textile. Alternatively, the absorbent substrate material can be made from materials having a capillary action, e.g. hollow fibers. However, the absorbent material can also consist of pressed materials, e.g. cellulose, glass fibers or other fibers. Furthermore, an absorbent, powdery or granular component of a multi-component adhesive can be in the form of a pad or tampon which is fastened to the shoe and then moistened or impregnated with the further component(s).

1. Device for raising the hoof (22) of an animal, such as a cow, comprising a shoe (24), such as a wood block, to be fastened to the hoof and which can be connected with the hoof by a connecting medium such as a single- or multi-component adhesive,
characterized therein
that a porous material having a reactive adhesive or a component provided therewith or consisting thereof to form the connecting medium between the shoe (24) and the hoof (22) is provided on the hoof-side surface (26) of the shoe (24).

2. Device according to claim 1,
characterized therein
that the porous material is absorbent.

3. Device according to claim 1 or 2,
characterized therein
that the porous material is hardening.

4. Device according to at least one of the preceding claims,
characterized therein
that the porous material is connected with the shoe (24).

5. Device according to at least one of the preceding claims,
characterized therein
that the porous material is placed on the hoof-side surface (26) of the shoe (24).

6. Device according to at least one of the preceding claims,
characterized therein
that the porous material, such as a substrate (28), is provided, e.g. impregnated, with a component of a two-component or multi-component adhesive or consists of said component.

7. Device according to at least one of the preceding claims,
characterized therein
that the porous material is provided, e.g. impregnated, with a single-component adhesive material, in particular a cyanacrylate-based material, or consists of said material.

8. Device according to at least one of the preceding claims,
characterized therein
that the porous material is a foam material and/or fleece material and/or textile material or contains said material.

9. Device according to at least one of the preceding claims,
characterized therein
that the porous material is formed by a pad and/or a tampon which is filled with powdery and/or granular material which is impregnated with the single component of the two- or multi-component adhesive or consists thereof.

10. Device according to at least one of the preceding claims,
characterized therein
that the porous material has an extent covering the desired hoof area.

11. Device according to at least one of the preceding claims,
characterized therein
that the porous material has an intake, at least in certain areas, for active medical substances.

12. Device according to at least one of the preceding claims,
characterized therein
that the porous material consists of a foam with closed and/or open pores.

13. Device according to at least one of the preceding claims,
characterized therein
that the porous material consisting of a foam material has a thickness of 0.1 mm to 30 mm, preferably 3 mm to 10 mm.

14. Device according to at least one of the preceding claims,
characterized therein
that the foam material has a pore size of 0.01 mm to 5 mm, preferably 0.1 mm to 2 mm.

15. Device according to at least one of the preceding claims,
characterized therein
that the adhesive material is a two-component adhesive based on urethane, acrylate/methacrylate, polyester, acrylic acid and/or expoxy resin.

16. Device according to at least one of the preceding claims,
characterized therein
that the porous material is impregnated with a peroxide and/or a substituted barbituric acid, preferably dibenzoyl peroxide and/or a 5-substituted barbituric acid.

17. Device according to at least one of the preceding claims,
characterized therein
that the polymerizing component to be added to the porous material for hardening the adhesive contains a catalyst such as amines or quarternary ammonium salts, metal ions, preferably p-toluidines, copper/cobalt ions and quarternary ammonium chlorides.

18. Device according to at least one of the preceding claims,
characterized therein
that the polymerizing component is a monomer based on polyester and/or acrylate/methacrylate, preferably styrene or methyl-, ethyl-, n-alkyl-methacrylate and/or hydroxy(-ethyl-,propyl-,n-alkyl)-methacrylate/acrylate and/or di-tri-tetra-methacrylates/acrylates.

19. Device according to at least one of the preceding claims,
characterized therein
that the porous material consists of a countercomponent of a reactive adhesive.

20. Device according to at least one of the preceding claims,
characterized therein
that the porous material consists of a reactive partner of a further component of the adhesive.

21. Device according to at least one of the preceding claims,
characterized therein
that the porous material is impregnated with a single-component material, preferably cyanacrylate-based, and/or with a microencapsulated and/or radiation-hardened adhesive.

22. Device according to at least one of the preceding claims,
characterized therein
that the porous material consists of a fabric-like material.

23. Device according to at least one of the preceding claims,
characterized therein
that the porous material consists of materials with capillary action, such as e.g. hollow fibers.

24. Device according to at least one of the preceding claims,
characterized therein
that the porous material consists of pressed materials, such as e.g. cellulose, glass fibers or other fibers.

25. A method for raising the hoof (22) of an animal, such as a cow, by fastening a shoe (24) to the hoof, characterized by the procedural steps:
fastening a porous material of a desired flat extension to the shoe (24), the material having been provided with a first component of a hardening multi-component adhesive prior to or after fastening to the shoe,
providing the material having the first component with at least a second component (30) of the adhesive,
pressing the shoe with the material containing the components against the hoof (22) and
hardening the adhesive for fixing the shoe to the hoof.

26. A method for raising the hoof (22) of an animal, such as a cow, by fastening a shoe (24) to the hoof, characterized by the procedural steps:
fastening a porous material of a desired flat extension to the shoe (24), the material having been provided with a single-component adhesive material prior to or after fastening to the shoe,
pressing the shoe with the material containing the adhesive material against the hoof (22) and
hardening the adhesive for fixing the shoe to the hoof.

27. A method according to claim 25 or 26,
characterized therein
that the hardening is accomplished and/or assisted by ultrasound, high-frequency radiation, electromagnetic radiation, such as light, and/or microwave radiation.
